(19) United States
(12) Patent Application Publication
(10) Pub. No.: US 2025/0292777 A1
(43) Pub. Date: Sep. 18, 2025

(54) DEEPFAKE DETECTION SYSTEM COMBINING DISCRIMINATIVE FEATURES FROM VOICED AND UNVOICED SEGMENTS OF SPEECH

(71) Applicant: Pindrop Security, Inc., Atlanta, GA (US)

(72) Inventor: Ganesh SIVARAMAN, Atlanta, GA (US)

(73) Assignee: Pindrop Security, Inc., Atlanta, GA (US)

(21) Appl. No.: 19/076,935

(22) Filed: Mar. 11, 2025

Related U.S. Application Data
(60) Provisional application No. 63/564,440, filed on Mar. 12, 2024.
(60) Provisional application No. 63/751,545, filed on Jan. 30, 2025.

(51) Int. Cl. G10L 17/18; G10L 17/06

(52) U.S. Cl. CPC G10L 17/18; G10L 17/06

(57) ABSTRACT

Disclosed are systems and methods including software processes executed by a server that detect audio-based synthetic speech (“deepfakes”). The server applies a machine-learning architecture that includes a segmentation engine trained to parse an audio signal into voiced-speech segments and unvoiced-speech segments. Each segment type is analyzed by respective deepfake detectors. A first deepfake detector generates a first risk score for the voiced-speech segment, while a second deepfake detector generates a second risk score for the unvoiced-speech segment. The machine-learning architecture includes fusion layers to algorithmically combine the risk scores to determine and overall risk score. In training, the server uses loss functions to calculate losses indicating distances or discrepancies between the generated risk scores and expected risk scores provided by training labels. Based on the loss, the server updates the parameters of the respective deepfake detectors or segmentation engine.

### CROSS-REFERENCE TO RELATED APPLICATIONS

This application claims the benefit of priority to U.S. Provisional Application No. 63/751,545, filed Jan. 30, 2025, and U.S. Provisional Application No. 63/564,440, filed Mar. 12, 2024, each of which incorporated by reference in its entirety.

### TECHNICAL FIELD

This application generally relates to systems and methods for managing, training, and deploying a machine learning architecture for call data processing. In particular, this application relates to using machine-learning techniques for mitigating deepfakes in fraudulent audio data.

### BACKGROUND

Automatic speaker verification (ASV) systems are often essential software programs for call centers. For instance, an ASV allows the callers or end-users (e.g., customers) to authenticate themselves to the call center based on the caller's voice during the phone call with a call center agent, or the ASV may capture spoken inputs to an interactive voice response (IVR) program of the call center. The ASV significantly reduces the time and effort of performing functions at the call center, such as authentication. However, ASVs are vulnerable to malicious attacks, such as a “presentation attack.” There are two types of presentation attacks. The first type is called “replay attack,” when a malicious actor could replay the recorded audio to the ASV system to gain unauthorized access to a victim's account. The second is called a “deepfake attack,” when a malicious actor employs software that outputs machine-generated speech (sometimes referred to as deepfake speech or machine-generated speech) using Text-To-Speech (TTS) or generative-AI software for performing speech synthesis or voice-cloning of any person's voice. The presentation attack generates voice signal outputs used to break (or “trick”) a voice biometrics function of the authentication programming of the call center system, thereby gaining access to the features and benefits of the call center system or to a particular victim's account.

Deepfake technology has made significant advancements in recent years, enabling the creation of highly realistic, but fake, still imagery, audio playback, and video playback, employable for any number of purposes, from entertainment to misinformation, to launching deepfake attacks. What is needed is improved means for detecting fraudulent uses of audio-based deepfake technology over telecommunications channels. The detection of audio deepfakes has become increasingly important as synthetic speech generation technologies advance. Current deepfake detection systems, particularly those based on deep neural networks, have achieved high accuracy in identifying synthetic speech. However, several shortcomings in the existing technology hinder the effectiveness and reliability of existing deepfake detection systems.

Current deepfake detection models do not accurately reflect certain acoustic features in audio signals. Humans typically rely on acoustic cues, such as unnatural pitch jitter, robotic intonation, acoustic artifacts, and unnatural sounding fricatives, to judge the quality of synthetic audio. Many deepfake systems can generate synthetic audio capable of mimicking and tricking human agents, voice biometric systems, and deepfake detection systems by approximating these acoustic features. However, current deepfake detection models do not effectively incorporate these cues, limiting the ability for deepfake detection models to detect synthetic audio based on such cues.

### SUMMARY

Disclosed herein are systems and methods capable of addressing the above-described shortcomings and may also provide any number of additional or alternative benefits and advantages. Embodiments include systems and methods for detecting fraudulent, deepfake, synthetic audio signals using a machine-learning architecture that detects voiced-speech and unvoiced portions of audio signals for discriminating deepfakes from genuine audio. The server applies a machine-learning architecture that includes a segmentation engine trained to parse an audio signal into voiced-speech segments and unvoiced-speech segments. Each segment type is analyzed by respective deepfake detectors. A first deepfake detector generates a first risk score for the voiced-speech segment, while a second deepfake detector generates a second risk score for the unvoiced-speech segment. The machine-learning architecture includes fusion layers to algorithmically combine the risk scores to determine and overall risk score. In training, the server uses loss functions to calculate losses indicating distances or discrepancies between the generated risk scores and expected risk scores provided by training labels. Based on the loss, the server updates the parameters of the respective deepfake detectors or segmentation engine.

Embodiments may include a computer-implemented method for detecting fraudulent speech based on voiced-speech and unvoiced-speech. The method may include: extracting, a computer, input features for an input audio signal including speech audio data having voiced-speech portions and unvoiced-speech portions; identifying, by the computer, a voiced-speech portion of the speech audio signal and an unvoiced-speech portion of the speech audio signal using a segmentation engine of a machine-learning architecture, the segmentation engine trained to identify instances of at least one of voiced-speech portions or unvoiced-speech portions according to the input features; generating, by the computer, a voiced-speech segment containing the voiced-speech portion from the speech audio data and an unvoiced-speech segment containing the unvoiced-speech portion from the speech audio data; generating, by the computer, a first risk score for the voiced-speech segment indicating a first likelihood that the input audio signal is fraudulent using a first deepfake detector of the machine-learning architecture based upon a set of voiced features for the voiced-speech segment; generating, by the computer, a second risk score for the unvoiced-speech segment of the input audio signal indicating a second likelihood that the input audio signal is fraudulent using a second deepfake detector of the machine-learning architecture based upon a set of unvoiced features for the unvoiced-speech segment; generating, by the computer, an overall risk score for the input audio signal based upon the first risk score and second risk score, the overall risk indicating a third likelihood that the input audio signal is fraudulent; and identifying, by the computer, the input audio signal as genuine or fraudulent based upon overall risk score.

The method may include extracting, by the computer, the set of voiced features for the voiced-speech segment and the set of unvoiced features for the unvoiced-speech segment.

The method may include extracting, by the computer, a first fakeprint feature vector embedding using the set of voiced features for the voiced-speech segment; and extracting, by the computer, a second fakeprint feature vector embedding using the set of unvoiced features for the unvoiced-speech segment.

The method may include detecting, by the computer, the voiced-speech portion based upon a pitch frequency indicative of the voiced-speech using a pitch detector of the segmentation engine.

The method may include detecting, by the computer, the unvoiced-speech based upon a pitch frequency indicative of the unvoiced-speech using a pitch detector of the segmentation engine.

The method may include detecting, by the computer, a non-speech portion of the input audio signal using a Speech Activity Detection (SAD) engine trained to trained to identify instances of non-speech portions according to the input features; and generating, by the computer, a non-speech segment containing the non-speech portion from the input audio signal; and filtering, by the computer, the non-speech segment from the input audio signal.

The method may include generating, by the computer, a third risk score for the input audio signal indicating a fourth likelihood that the input audio signal is fraudulent using a third deepfake detector of the machine-learning architecture based upon a set of features for the input audio signal having the voiced-speech segment, unvoiced-speech segment, and non-speech segment. The computer may generate the overall risk score based upon the first risk score, the second risk score, and the third risk score.

The method may include generating, by the computer, a loss for the machine-learning architecture using a loss function, the loss indicating a distance between the overall risk score as generated for the input audio signal and an expected overall risk score indicated by a training label associated with the input audio signal; and updating, by the computer, one or more parameters of at least one of the first deepfake detector or the second deepfake detector based upon the loss.

The method may include generating, by the computer, a loss for a first deepfake detector using a loss function, the loss indicating a distance between the first risk score as generated for the voiced-speech segment and an expected first risk score indicated by a training label associated with the input audio signal; and updating, by the computer, one or more parameters of the first deepfake detector based upon the loss.

The method may include generating, by the computer, a loss for a second deepfake detector using a loss function, the loss indicating a distance between the second risk score as generated for the unvoiced-speech segment and an expected second risk score indicated by a training label associated with the input audio signal; and updating, by the computer, one or more parameters of the second deepfake detector based upon the loss.

Embodiments may include a system for detecting fraudulent speech based on voiced-speech and unvoiced-speech. The system may include a computer having at least one processor, where the computer may be configured to: extract input features for an input audio signal including speech audio data having voiced-speech portions and unvoiced-speech portions; identify a voiced-speech portion of the speech audio signal and an unvoiced-speech portion of the speech audio signal using a segmentation engine of a machine-learning architecture, the segmentation engine trained to identify instances of at least one of voiced-speech portions or unvoiced-speech portions according to the input features; generate a voiced-speech segment containing the voiced-speech portion from the speech audio data, and an unvoiced-speech segment containing the unvoiced-speech portion from the speech audio data; generate a first risk score for the voiced-speech segment indicating a first likelihood that the input audio signal is fraudulent using a first deepfake detector of the machine-learning architecture based upon a set of voiced features for the voiced-speech segment; generate a second risk score for the unvoiced-speech segment of the input audio signal indicating a second likelihood that the input audio signal is fraudulent using a second deepfake detector of the machine-learning architecture based upon a set of unvoiced features for the unvoiced-speech segment; generate an overall risk score for the input audio signal based upon the first risk score and second risk score, the overall risk indicating a third likelihood that the input audio signal is fraudulent; and identify the input audio signal as genuine or fraudulent based upon overall risk score.

The computer may be further configured to extract the set of voiced features for the voiced-speech segment and the set of unvoiced features for the unvoiced-speech segment.

The computer may be further configured to extract a first fakeprint feature vector embedding using the set of voiced features for the voiced-speech segment; and extract a second fakeprint feature vector embedding using the set of unvoiced features for the unvoiced-speech segment.

The computer may be further configured to detect the voiced-speech portion based upon a pitch frequency indicative of the voiced-speech using a pitch detector of the segmentation engine.

The computer may be further configured to detect the unvoiced-speech based upon a pitch frequency indicative of the unvoiced-speech using a pitch detector of the segmentation engine.

The computer may be further configured to detect a non-speech portion of the input audio signal using a Speech Activity Detection (SAD) engine trained to trained to identify instances of non-speech portions according to the input features; generate a non-speech segment containing the non-speech portion from the input audio signal; and filter the non-speech segment from the input audio signal.

The computer may be further configured to generate a third risk score for the input audio signal indicating a fourth likelihood that the input audio signal is fraudulent using a third deepfake detector of the machine-learning architecture based upon a set of features for the input audio signal having the voiced-speech segment, unvoiced-speech segment, and non-speech segment. The computer may generate the overall risk score based upon the first risk score, the second risk score, and the third risk score.

The computer may be further configured to generate a loss for the machine-learning architecture using a loss function, the loss indicating a distance between the overall risk score as generated for the input audio signal and an expected overall risk score indicated by a training label associated with the input audio signal; and update one or more parameters of at least one of the first deepfake detector or the second deepfake detector based upon the loss.

The computer may be further configured to generate a loss for a first deepfake detector using a loss function, the loss indicating a distance between the first risk score as generated for the voiced-speech segment and an expected first risk score indicated by a training label associated with the input audio signal; and update one or more parameters of the first deepfake detector based upon the loss.

The computer may be further configured to generate a loss for a second deepfake detector using a loss function, the loss indicating a distance between the second risk score as generated for the unvoiced-speech segment and an expected second risk score indicated by a training label associated with the input audio signal; and update one or more parameters of the second deepfake detector based upon the loss.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 shows components of an example system for handling and analyzing calls from callers, according to an embodiment.

FIG. 2 shows dataflow amongst components of a system for deepfake detection in caller audio data using a machine-learning architecture, according to an embodiment.

FIG. 3 is a flowchart showing operations of a computer-implemented method for deepfake detection in caller audio using a machine-learning architecture based on voiced-speech and unvoiced-speech, according to an embodiment.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Existing anti-fraud systems have implemented neural network architectures for detecting synthetic speech. The current state-of-the-art anti-spoofing systems take raw speech waveforms as input fed through a deep convolutional neural network (CNN) followed by temporal pooling of features to predict whether the presented speech utterance is bona fide or spoofed.

Human speech production involves a complex coordination of several muscular movements. The vibration of the vocal cords play a central role in producing vowel sounds which form the major content of speech. But the vocal fold vibrations are intermittently stopped to produce unvoiced sounds like unvoiced stop consonants and fricatives. Free flowing speech involves a rhythmic dance between the voiced and unvoiced states of vocal folds. Unvoiced fricatives look similar to white noise but are often colored by the adjacent sounds due to coarticulation. The extent of such coarticulatory effects in unvoiced sounds is not uniform in genuine speech. Text-to-Speech (TTS) synthesis and voice conversion (VC) systems often produce similar waveforms for all repetitions of the fricatives and stops. As such, the unvoiced regions could hold important cues for discriminating genuine from spoofed speech.

Existing anti-fraud systems overlook these aspects of voiced and unvoiced speech in TTS and VC systems. Although the unvoiced regions could hold important cues for discriminating genuine speech from synthetic speech, existing anti-fraud systems do not consider or leverage these characteristics of unvoiced regions.

The segmentation of speech into voiced and unvoiced regions using pitch detection and estimation also presents challenges. Current anti-fraud system may be ineffective in noisy environments, leading to inaccuracies in the segmentation process. This limitation affects the overall performance of deepfake detection systems, as the effectiveness of detecting synthetic speech based on these segments is compromised.

Embodiments described herein implement a computer-implemented machine-learning architecture for deepfake detection that temporally segments speech utterances of an input audio signal into voiced-speech portions and unvoiced-speech portions based on pitch detection. A segmentation engine of the machine-learning architecture may implement a pitch detector that detects or identifies a pitch frequency of an utterance as a measure of voicing. The pitch detector may detect pitch based on peak-finding on an autocorrelation function, or implement a Probabilistic YIN (pYIN) algorithm to detect whether a speech frame is voiced or unvoiced in a time-frequency domain or spectro-temporal representation of the audio signal. Segmentation engine then parses or segments the audio signal into voiced-speech segments of the voiced-speech portions and unvoiced-speech segments of the unvoiced-portions. The machine-learning architecture feeds the voiced-speech segments into a voiced-speech deepfake detector having a neural network architecture or other type of machine-learning model trained to detect fraudulent, deepfake, synthetic speech in the voiced-speech portions. The machine-learning architecture feeds the unvoiced-speech segments into an unvoiced-speech deepfake detector having a neural network architecture or other type of machine-learning model trained to detect fraudulent, deepfake, synthetic speech in the unvoiced-speech portions. Scoring layers of the deepfake detectors generate respective risk scores representing the likelihood that the voiced-speech segments or unvoiced-speech segments are genuine or fraudulent. Fusion layers and classifier layers may fuse the risk scores to generate an overall risk score and determine a classification of the input audio signal as being genuine or fraudulent based upon comparing the overall risk score or other risk scores against one or more fraud detection thresholds.

Another shortcoming in deepfake detection systems is a lack of transparency and interpretability of the outputs. While these existing black box neural network architectures can achieve decent results, these existing neural networks often fail to provide reasoning or outputs to human evaluators. This lack of transparency makes it difficult for users to trust the system's outputs and understand the basis for conclusions.

Embodiments described herein implement an explainability engine that generates various types visualized representations of the segments and the energy or frequency characteristics of synthetic speech, with various annotations or highlighted indicators, to visually explain the fraud classification and the portions of the audio signal that contributed to the fraud classification.

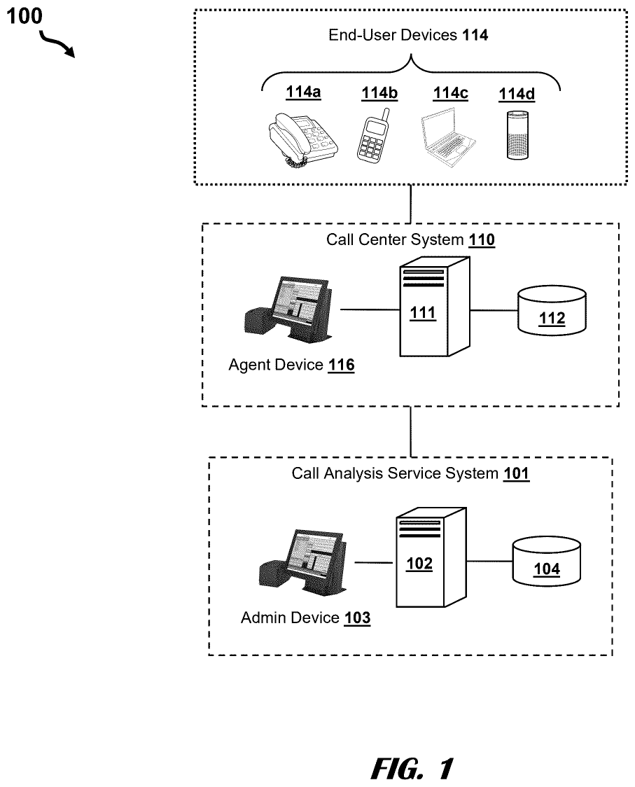

FIG. 1 shows components of an example system 100 for handling and analyzing calls from callers, according to an embodiment. The system 100 includes components that, for example, recognize and authenticate callers, and evaluate fraud risks for calls. Evaluating or detecting fraud risks may include operations for identifying instances of fraudulent audio signals, such as deepfake or synthetic audio signals, received during a conversation over a telephone call or any app-based call having audio features (e.g., WhatsApp® call, Skype® call). The system 100 comprises a call analytics system 101, call center systems 110 of customer enterprises (e.g., companies, government entities, universities), and caller devices 114a-114d (generally referred to as end-user devices 114 or an end-user device 114). The call analytics system 101 includes analytics servers 102, analytics databases 104, and admin devices 103. The call center system 110 includes call center servers 111, call center databases 112, and agent devices 116.

Embodiments may comprise additional or alternative components or omit certain components from those of FIG. 1, and still fall within the scope of this disclosure. It may be common, for example, to include multiple call center systems 110 or for the call analytics system 101 to have multiple analytics servers 102. Embodiments may include or otherwise implement any number of devices capable of performing the various features and tasks described herein. For example, the FIG. 1 shows the analytics server 102 as a distinct computing device from the analytics database 104. In some embodiments, the analytics database 104 may be integrated into the analytics server 102.

Various hardware and software components of one or more public or private networks may interconnect the various components of the system 100. Non-limiting examples of such networks may include Local Area Network (LAN), Wireless Local Area Network (WLAN), Metropolitan Area Network (MAN), Wide Area Network (WAN), and the Internet. The communication over the network may be performed in accordance with various communication protocols, such as Transmission Control Protocol and Internet Protocol (TCP/IP), User Datagram Protocol (UDP), and IEEE communication protocols. Likewise, the caller devices 114 may communicate with callees (e.g., call center systems 110) via telephony and telecommunications protocols, hardware, and software capable of hosting, transporting, and exchanging audio data associated with telephone calls. Non-limiting examples of telecommunications hardware may include switches and trunks, among other additional or alternative hardware used for hosting, routing, or managing telephone calls, circuits, and signaling. Non-limiting examples of software and protocols for telecommunications may include SS7, SIGTRAN, SCTP, ISDN, and DNIS among other additional or alternative software and protocols used for hosting, routing, or managing telephone calls, circuits, and signaling. Components for telecommunications may be organized into or managed by various different entities, such as carriers, exchanges, and networks, among others.

The description of FIG. 1 mentions circumstances in which a calling end-user (caller) places a current or inbound call through various communications channels to contact and interact with the services offered by the call center system 110, though the operations and features of the speaker verification and fraud-risk detection techniques described herein may be applicable to any circumstances involving a voice-based interface between the caller and the services offered by the call center system 110. The call may be placed using various types of telephony communications, implementing the hardware, software, and protocols corresponding to the type of communications channel. For instance, the operations described herein could be implemented by any call center system 110 that receives speaker audio inputs via one or more types of communications channels. The end-users can, for example, access user accounts, services, or features of the service provider and service provider's call center system 110, which may include interacting with human agents or with software applications (e.g., cloud application, website-based application with voice interface) hosted by call center servers 111. In some implementations, the users of the service provider's call center system 110 may access the user accounts or other features of the service provider by placing calls using the various types of end-user devices 114. The callers may also access the user accounts or other features of the service provider using software executed by certain end-user devices 114 configured to exchange data and instructions with software programming (e.g., the cloud application) hosted by the call center servers 111. The customer call center system 110 may include, for example, human agents who converse with callers during telephone calls, Interactive Voice Response (IVR) software executed by the call center server 111, or the cloud software programming executed by the call center server 111. The customer call center 110 need not include any human agents, such that the end-user interacts only with the IVR system or the cloud software application.

The end-user devices 114 may be any communications or computing device that the caller operates to access the services of the call center system 100 through the various types of communications channels. The end-user devices 114 comprise or connect with a microphone device for capturing audio waveforms and converting the audio waveforms to electrical audio signals. The caller may place the call to the call center system 110 through a telephony network or through a software application executed by the caller device 114. A device of the call center system 110, such as a provider server 111, captures and forwards the input audio signal data to the analytics system 101 to perform the various processes described herein. Non-limiting examples of caller devices 114 may include landline phones 114a, mobile phones 114b, calling computing devices 114c, edge devices 104d, or other types of electronic devices capable of voice communications. The landline phones 114a and mobile phones 114b are telecommunications-oriented devices (e.g., telephones) that communicate via telecommunications channels. The end-user device 114 is not limited to the telecommunications-oriented devices or channels. For instance, in some cases, the mobile phones 114b may communicate via a computing network channel (e.g., the Internet). The caller device 114 may also include an electronic device comprising a processor and/or software, such as a caller computing device 114c or edge device implementing, for example, voice-over-IP (VOIP) telecommunications, data-streaming via a TCP/IP network, or other computing network channel. The edge device 114d may include any Internet of Things (IoT) device or other electronic device for network communications. The edge device 114d could be any smart device capable of executing software applications and/or performing voice interface operations. Non-limiting examples of the edge device 114d may include voice assistant devices, automobiles, smart appliances, and the like.

In some embodiments, the analytics server 102 or provider server 111 executes software for a webserver that hosts website or web application, accessible to the end-user device 114 via the one or more networks. The end-user devices 114 execute a native application or web browser that navigates to, or otherwise accesses, the various services or operations of the webserver by communicating with the analytics server 102 or the provider server 111. The end-user device 114 may request or receive various types of files, data, or messages from the webserver to interact with the services of the analytics system 101 or call center system 110, according to various software programs and protocols for communicating over the networks and providing information for display in a user interface, presented at a screen of the end-user device 114. For instance, the analytics server 102 may execute processes for generating and transmitting a verification prompt for display at the user interface of the end-user device 114. In some cases, the user may interact with the provider server 111 and the analytics server 102 using one or more end-user devices 114. As an example, the caller could place a call to the call center system 110 using a landline phone 114a and receive the verification prompt at a browser or application of a computer 114c. As another example, the caller could place a call to the call center system 110 using a smart phone 114b and receive the verification prompt at an application or browser of the smart phone 114b; or, similarly, place the call using a computer 114c and receive the verification prompt at an application or browser of the computer 114c.

The call center system 110 comprises various hardware and software components that capture and store various types of data or metadata related to the caller's contact with the call center system 110. This data may include, for example, audio recordings of the call or the caller's voice and metadata related to the protocols and software employed for the particular communication channel. The audio signal captured with the caller's voice has a quality based on the particular communication used. For example, the audio signals from the landline phone 114a will have a lower sampling rate and/or lower bandwidth compared to the sampling rate and/or bandwidth of the audio signals from the edge device 114d.

The call analytics system 101 and the call center system 110 represent network infrastructures 101, 110 comprising physically and logically related software and electronic devices managed or operated by various enterprise organizations. The devices of each network system infrastructure 101, 110 are configured to provide the intended services of the particular enterprise organization.

The analytics server 102 of the call analytics system 101 may be any computing device comprising hardware (e.g., at least one processor, non-transitory machine-readable media) and software (e.g., executable machine-readable instructions stored in non-transitory media), and capable of performing the various processes and tasks described herein. The analytics server 102 may host or be in communication with the analytics database 104, and receives and processes call data (e.g., audio recordings, metadata) received from the one or more call center systems 110. Although FIG. 1 shows only single analytics server 102, the analytics server 102 may include any number of computing devices. In some cases, the computing devices of the analytics server 102 may perform all or sub-parts of the processes and benefits of the analytics server 102. The analytics server 102 may comprise computing devices operating in a distributed or cloud computing configuration and/or in a virtual machine configuration. It should also be appreciated that, in some embodiments, functions of the analytics server 102 may be partly or entirely performed by the computing devices of the call center system 110 (e.g., the call center server 111).

The analytics server 102 executes audio-processing software that includes one or more machine-learning architectures having functions, layers, and other aspects of a machine-learning architecture (e.g., machine-learning models) to perform various types of operations for speaker recognition, verification and authentication, and fraud detection (e.g., deepfake or liveness detection; spoof detection). For ease of description, the analytics server 102 is described as executing a single machine-learning architecture, though multiple neural network architectures could be employed in some embodiments. The machine-learning architecture includes various sub-components implemented through software programming executed by the analytics server 102, such as input layers, layers for voiced-speech segmentation and unvoiced-speech segmentation, embedding extraction, and scoring layers, among others.

The machine-learning architecture operates logically in several operational phases, including a training phase and a deployment phase (sometimes referred to as a “test” phase, “testing,” or “inference time”). The inputted audio signals processed by the analytics server 102 and the machine-learning architecture include training audio signals processed during the training phase and inbound audio signals processed during the deployment phase. The analytics server 102 applies the machine-learning architecture to each type of inputted audio signal during the corresponding operational phase.

The machine-learning architecture includes the input layers for extracting certain types of features from an input audio signal and performing additional preprocessing or data augmentation operations, a SAD engine for identifying and parsing non-speech segments, a segmentation engine for identifying and parsing voiced-speech segments and unvoiced-segments, and a deepfake detector for determining whether the input audio signal is genuine or fraudulent (e.g., likely contains deepfake audio data) using the voiced-speech segments and unvoiced-segments of the input audio signal.

The analytics server 102 or other computing device of the system 100 (e.g., call center server 111) can perform various pre-processing operations and/or data augmentation operations on the input audio signals. Non-limiting examples of the pre-processing operations on inputted audio signals may include parsing and segmenting the audio signal into frames or segments, performing one or more transformation functions (e.g., FFT, SFT), and extracting features or feature vectors, among other potential pre-processing operations. Non-limiting examples of data augmentation operations include audio clipping, background or resonance noise augmentation, adversarial noise augmentation, frequency augmentation, and duration augmentation, among other potential data augmentation operations. In some cases, the analytics server 102 may executes certain pre-processing or data augmentation operations as operations of input layers of the machine-learning architecture. Additionally or alternatively, in some cases, the analytics server 102 may perform certain pre-processing or data augmentation operations prior to feeding the input audio signals into the input layers of the machine-learning architecture.

During the training phase, the analytics server 102 receives training audio signals of various acoustic characteristics (e.g., voiced-speech, unvoiced-speech samples, bandwidth, sample rate, types of degradation) from one or more corpora, which may be stored in an analytics database 104 or other storage medium. The training audio signals include clean audio signals (sometimes referred to as samples) and simulated audio signals, each of which the analytics server 102 uses to train the various layers of the machine-learning architecture. The clean audio signals are audio samples containing speech audio signals in which the speech and the features are identifiable by the analytics server 102 and may also include voiced-speech portions and unvoiced-speech portions. The input audio signals may also include non-speech portions (no speaker is speaking). Certain data augmentation operations executed by the analytics server 102 retrieve or generate the simulated audio signals for data augmentation purposes during training. The data augmentation operations may generate additional versions or segments of a given training signal containing manipulated features mimicking a particular type of signal degradation or distortion. The analytics server 102 stores the training audio signals into the non-transitory medium of the analytics server 102 and/or the analytics database 104 for future reference or operations of the machine-learning architecture.

The input layers may include programming for extracting low-level input features from the input audio signal. For instance, the input layers convert the input audio signal into a transform domain, such as a spectro-temporal representation, using one or more transformation functions. This representation captures the frequency content of the audio signal over time, providing a detailed view of the signal characteristics. The input layers may extract the input features from the input audio signal and executes a segmentation engine. The input layers may feed these extracted input features to the segmentation engine.

The segmentation engine includes software programming of a machine-learning model trained to identify voiced-speech portions and unvoiced-speech portions of the input audio signal. In some implementations, the machine-learning model of the segmentation engine includes a pitch detector. The pitch detector is programmed to analyze, for example, frequency and amplitude characteristics of input audio signals to identify the voiced-speech portions and the unvoiced-speech portions. The voiced-speech portions typically exhibit periodic waveforms and energy, with higher amplitudes and energy caused by the vibration of the vocal cords. The unvoiced-speech portions generally display random waveforms and energy with lower amplitudes and energy because of the lack of vocal cord vibrations. By executing a transformation function, such as a spectro-temporal representation, the feature extractor of the input layers converts the input audio signal into a transform domain that indicates the amount of energy present. This energy at the pitch of human speech differs distinctly between voiced-speech portions and unvoiced speech portions. The pitch detector of the segmentation engine may be trained to analyze the amount of energy to identify or detect voiced-speech portions and unvoiced-speech portions.

The segmentation engine, utilizing the pitch detector's output, parses the input audio signal into voiced-speech segments containing the identified voiced-speech portions and unvoiced-speech segments containing the identified unvoiced-speech portions.

In some implementations, the segmentation engine generates or implements a voicing flag for the detected voiced-speech portions. The voicing flag is a binary indicator (0 or 1) used to indicate or classify segments of the audio signal as either voiced-speech or unvoiced-speech. The asserted voicing flag (1) indicates that a segment contains periodic energy corresponding to vocal fold vibrations, typically associated with vowels and voiced consonants. The unasserted voicing flag (0) indicates that the segment lacks periodic energy, typically associated with unvoiced consonants and silence. The voicing flag is generated or derived by the segmentation engine using the output of a pitch detector. As an example, the pitch detector analyzes the audio signal to determine the presence of pitch frequency within a specified range (e.g., 80 Hz to 250 Hz). The segmentation engine compares the pitch frequency determination of the pitch detector against a voiced-speech detection threshold to produce the binary value of the voicing flag. If the pitch frequency is detected, the voicing flag is set to 1; otherwise, the voicing flag is set to 0.

The segmentation engine references the voicing flag for the portions of the input audio signal to parse or segment the audio signal into voiced-speech segments and unvoiced-speech segments, where the segmentation engine multiplies the audio waveform for the portions with the voicing flag. This results in two separate waveforms: one containing only voiced-speech segments and the other containing only unvoiced-speech segments. These segmented waveforms are then ingested by separate deepfake detectors to train or evaluate separate machine-learning models of the deepfake detectors for voiced-speech segments and unvoiced-speech segments, which may improve the accuracy of deepfake detection.

In some embodiments, the machine-learning architecture includes a SAD engine including software programming of a machine-learning model for identifying non-speech portions and generating non-speech segments. The SAD engine analyzes the input audio signal to detect intervals where no speech is present. The SAD engine utilizes machine-learning models trained to recognize features indicative of speech or non-speech, such as ambient noise, silence, or background sounds. The input layers execute the transformation functions to convert the audio signal into a frequency domain representation, capturing spectral characteristics over time. The SAD engine then compares these characteristics against learned patterns to identify portions containing speech activity or devoid of speech activity. Once detected, the SAD engine may isolate or flag the non-speech portions, thereby differentiating the non-speech portions from the speech portions within the input audio signal. The SAD engine may generate and store non-speech segments corresponding to the non-speech portions into non-transitory machine-readable storage medium of the analytics server 102 or other computing device of the system 100 (e.g., analytics database 104, call center databases 112). In some implementations, the SAD engine may generate an updated version of the input audio signal that omits the non-speech segments.

The deepfake detectors of the machine-learning architecture includes layers of one or more machine-learning models programmed and trained for determining whether an input audio signal is genuine or fraudulent, or otherwise detecting instances of fraud (e.g., deepfakes, spoofing) in the input audio signal. Layers of a neural network within a deepfake detector are trained to operate as embedding extractors that generate feature vectors representing certain types of embeddings using features indicative of fraudulent audio signals (sometimes referred to as “fakeprints” or “spoofprints”). As an example, the fakeprint embedding extractor may be a neural network architecture (e.g., CNN, ResNet, SyncNet) that processes a first set of features extracted from certain segments of the input audio signals, where the fakeprint extractor comprises any number of convolutional layers, statistics layers, and fully-connected layers and trained according to one or more types of loss functions.

The deepfake detectors include scoring layers and/or classifier layers that are programmed and trained to generate the risk score and fraud determination using the corresponding fakeprints. The scoring layers generate the risk scores based upon similarities between the fakeprint and previously trained or generated fraud-detection clusters or centroids. The machine-learning architecture feeds the fakeprint to the fraud classifier or scoring layers to perform various scoring operations. The scoring layers and/or the fraud classifier perform a distance scoring operation that determines the distance (e.g., similarities, differences) between the fakeprint and a centroid or fakeprint feature vector previously generated as fraud-detection cluster using training fakeprints extracted for the training audio signals. Each risk score indicates the likelihood that the input audio signal is genuine or fraudulent, where the particular segments include deepfake or spoofed attributes. The risk score may be a value generated by the scoring layers and/or fraud classifier based on one or more scoring operations (e.g., distance scoring). For instance, the scoring layers or classifier of the deepfake detector determines whether the distance score or other outputted values satisfy threshold values.

Example embodiments of the deepfake detection engines may be found in U.S. application Ser. No. 18/646,228, U.S. Pat. No. 11,862,177, each of which is incorporated by reference in its entirety.

The machine-learning architecture includes different deepfake detectors trained for different types of segments. For instance, a first deepfake detector analyzes the voiced-speech segments to generate a first risk score indicating a likelihood that the voiced-speech segments contain fraud and/or an indicator that the voiced-speech segments are genuine or fraudulent. A second deepfake detector analyzes the unvoiced-speech segments to generate a second risk score indicating a likelihood that the unvoiced-speech segments contain fraud and/or an indicator that the unvoiced-speech segments are genuine or fraudulent. Optionally, a third deepfake detector analyzes the features of the entire input audio signal, including the voiced-speech segments, the unvoiced-segments, and the non-speech segments to generate a third risk score indicating a likelihood that the whole input audio signal contains fraud and/or an indicator that the whole input audio signal is genuine or fraudulent.

The machine-learning architecture includes fusion layers for fusing or otherwise algorithmically combining the risk scores or fraud classifications generated by the one or more deepfake detectors. For instance, the fusion layers combine the risk scores from the various deepfake detectors a using a weighted average to generate an overall signal risk score. The fusion layers may include classifier layers that determine whether the overall risk score satisfies a fraud detection threshold score. The classifier layers of the fusion layers may, for example, determine that the input audio score is fraudulent in response to determining that the overall risk score satisfies the fraud detection threshold.

In some embodiments, rather than fusing the final risk scores, the machine-learning architecture fuses the fakeprint embeddings from the embedding extractor of the first deepfake detector and the embedding extractor of the second deepfake detector by concatenating the fakeprints to generate a complete fakeprint, which the machine-learning architecture feeds to a third deepfake detector that generates an overall signal risk score. In this way, this approach leverages the combined fakeprint feature vector embeddings extracted from both the voiced-speech segments and unvoiced-segments.

In some embodiments, the machine-learning architecture includes a single deepfake detector having a neural network with attention, where the machine-learning model is programmed and trained to process both the voiced-speech segments and the unvoiced-segments, using attention mechanisms to learn and fuse the relevant fakeprint features internally. In such embodiments, the neural network of the third deepfake detector network generates a single, overall signal risk score based on a combined fakeprint feature vector.

The analytics server 102 may generate a notification or other outputs for display at a user interface of a client device (e.g., agent devices 116, admin devices 103, end-user devices 114) indicating the results of the deepfake detectors or outputs generated by other components of machine-learning architecture.

In some embodiments, the machine-learning architecture or other software component of the analytics server 102 executes an explainability engine. The analytics server 102 executing the explainability engine begins by processing the input audio data to detect potential deepfake characteristics using the machine-learning architecture. The explainability engine may obtain the features or fakeprints representing the voiced-speech segments and unvoiced-segments, and compares the features or fakeprints against a baseline of genuine speech patterns. The analytics server 102 may generate a detailed spectral analysis for display at a graphical user interface of a client computing device (e.g., admin devices 103, agent devices 116, end-user device 114), highlighting areas where the features of the segments deviate from natural speech. The explainability engine generates a visual representation, such as spectrograms and average magnitude spectra, which illustrate the differences between bona fide and fraudulent synthetic or deepfake speech. The explainability engine also employs techniques, such as Shapley Additive Explanations (SHAP), to indicate specific portions within the visual representation of the audio signal that contribute most to the fraud classification.

The analytics server 102 may generate and transmit the results of the explainability engine for display at the user interface the client device (e.g., admin devices 103, agent devices 116, end-user device 114). The graphical output includes and displays the spectrograms with annotated regions that are flagged as suspicious, using color-coded heat maps to indicate the degree of deviation from natural speech. Users can interact with the graphical output displayed at the graphical user interface to explore specific segments of the audio, instructing the client computing device to playback certain portions of the audio signal and listening to the flagged regions to understand the anomalies. Additionally, the graphical user interface provides summary statistics and confidence score, helping users grasp the reliability of the deepfake detection. This detailed and user-friendly presentation enables forensic experts, security analysts, and call center agents to make informed decisions, enhancing transparency and trust in the deepfake detection process.

The analytics database 104 and/or the call center database 112 may contain any number of corpora of training audio signals that are accessible to the analytics server 102 via one or more networks. In some embodiments, the analytics server 102 employs supervised training to train the machine-learning models of the machine-learning architecture, where the analytics database 104 includes labels associated with the training audio signals that indicate, for example, the characteristics or features of the training audio signals. An administrator may configure the analytics server 102 to select the training audio signals having certain characteristics or features.

The call center server 111 of a call center system 110 executes software processes for managing a call queue and/or routing calls made to the call center system 110 through the various channels, where the processes may include, for example, routing calls to the appropriate call center agent devices 116 based on the inbound caller's comments, instructions, IVR inputs, or other inputs submitted during the inbound call. The call center server 111 can capture, query, or generate various types of information about the call, the caller, and/or the caller device 114 and forward the information to the agent device 116, where a graphical user interface (GUI) of the agent device 116 displays the information to the call center agent. The call center server 111 also transmits the information about the inbound call to the call analytics system 101 to preform various analytics processes on the inbound audio signal and any other audio data. The call center server 111 may transmit the information and the audio data based upon preconfigured triggering conditions (e.g., receiving the inbound phone call), instructions or queries received from another device of the system 100 (e.g., agent device 116, admin device 103, analytics server 102), or as part of a batch transmitted at a regular interval or predetermined time.

The admin device 103 of the call analytics system 101 is a computing device allowing personnel of the call analytics system 101 to perform various administrative tasks or user-prompted analytics operations. The admin device 103 may be any computing device comprising a processor and software, and capable of performing the various tasks and processes described herein. Non-limiting examples of the admin device 103 may include a server, personal computer, laptop computer, tablet computer, or the like. In operation, the user employs the admin device 103 to configure the operations of the various components of the call analytics system 101 or call center system 110 and to issue queries and instructions to such components.

The agent device 116 of the call center system 110 may allow agents or other users of the call center system 110 to configure operations of devices of the call center system 110. For calls made to the call center system 110, the agent device 116 receives and displays some or all of the relevant information associated with the call routed from the call center server 111. The agent device 116 includes a user interface that presents the information determined by the analytics server 102 about the caller or end-user device, including one or more scores or determinations, such as a message or alert notification indicating the call is likely fraud. The admin device allows the call center to agent to manage the agent's ongoing call status or queue, which includes allowing the agent to reject calls or route calls or otherwise perform mitigation actions when the analytics server 102 determines and indicates that the call is likely fraud.

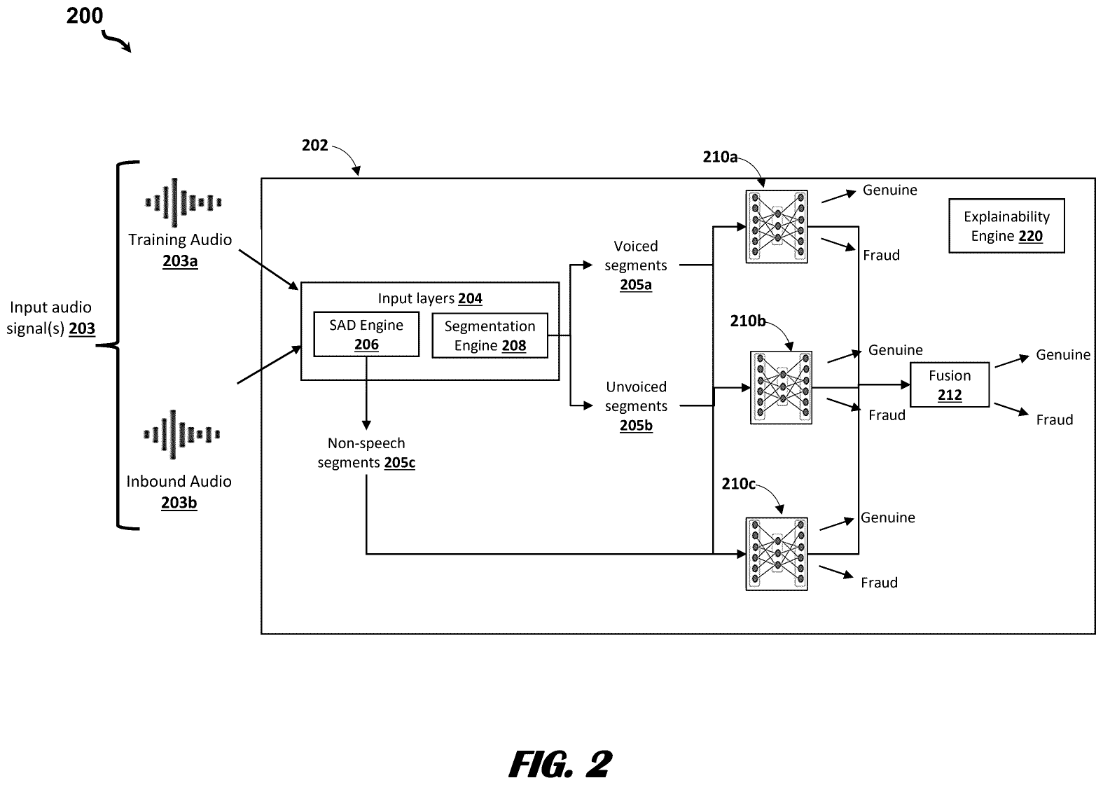

FIG. 2 shows dataflow amongst components of a system 200 for deepfake detection in caller audio data using a machine-learning architecture, according to an embodiment. The system 200 includes a server (e.g., analytics server 102) executing software programming and routines that implement a machine-learning architecture 202 for deepfake detection. In the example system 200, the server executes the software programming of machine-learning layers of machine-learning models the machine-learning architecture 202 for detecting deepfakes in input audio signals 203a-203b (generally referred to as input audio signals 203 or an input audio signal 203) at various operational phases (e.g., training, deployment). For instance, at a training phase, the server executes the machine-learning architecture 202 using training audio signals 203a. At a deployment phase, the server executes the machine-learning architecture using inbound audio signals 203b. For ease of description and understanding, the various software components and operations are executed by the server, though the software or operations may be executed by any number of computing devices comprising hardware components (e.g., processor, non-transitory storage medium) and software components that are capable of performing the operations of the server described herein.

The server includes the software programming that execute the various functions, layers, or other aspects (e.g., machine-learning models) of the machine-learning architecture 202 for processing one or more input audio signals 203 and detecting deepfakes that may occur in an input audio signal 203. The machine-learning architecture 202 includes input layers 204 and deepfake detectors 210a-210c (generally referred to as deepfake detectors 210), among other software components for handling the input audio signals 203. The input layers 204 may include an optional Speech Activity Detection (SAD) engine 206 and a segmentation engine 208. The input layers 204 generates or parses the input audio signal 203 into 205a-205c (generally referred to as segments 205), including voiced-speech segments 205a, unvoiced-segments 205b, and, optionally, non-speech segments 205c. The deepfake detectors 210 analyze features of the segments 205 to generate one or more risk scores and determine whether the input audio signal 203 is genuine or fraudulent.

The training audio signals 203a used for training the components of the machine-learning architecture 202 include a diverse set of audio samples with varying acoustic characteristics, having features indicative of whether a training audio signal 203a is genuine or fraudulent. The training audio signals 203a may include bona fide or genuine audio samples and fraudulent audio samples. The genuine audio samples of the training audio signals 203a are clean audio signals containing clear and identifiable speech audio, which may be verified or known to be originated from a trusted or verified source. The genuine samples include voiced-speech portions and unvoiced-speech portions. In some implementations, the training audio signals 203a include non-speech portions. The genuine audio samples further include features indicating that the input audio signal 203 is genuine. The fraudulent audio samples of the training audio signals 203a contain features indicating that the training audio signals 203a contain fraud.

The input layers 204 include executable operations for ingesting audio signals 203 and performing various pre-processing and augmentation operations. Non-limiting examples of the pre-processing operations include extracting low-level input features from an input audio signal 203, parsing and segmenting the input audio signal 203 into frames and segments, and performing one or more transformation functions, such as Short-time Fourier Transform (SFT) or Fast Fourier Transform (FFT), among other potential pre-processing operations. Non-limiting examples of augmentation operations include audio clipping, noise augmentation, frequency augmentation, duration augmentation, and the like.

The segmentation engine 208 includes software routines for a machine-learning model programmed for parsing and segmenting the input audio signal 203 into frames and segments. The segmentation engine 208 is trained to identify instances of voiced-speech and instances of unvoiced-speech occurring in an input audio signal 203. The segmentation engine 208 may parse the input audio signal 203 according to the identified voiced-speech portions and the unvoiced-speech portions, which the segmentation engine 208 uses to generate or otherwise output a set of one or more voiced-speech segments 205a containing the identified voiced-speech portions of the input audio signal 203 and a set of one or more unvoiced-speech segments 205b containing the identified unvoiced-speech portions of the input audio signal 203.

In some embodiments, the segmentation engine 208 includes a machine-learning model programmed and trained as a pitch detector. In such embodiments, the segmentation engine 208 identifies the voiced-speech portions and unvoiced-speech portions by analyzing the frequency and amplitude characteristics of the input audio signal 203. Generally, waveforms of voiced-speech portions typically include periodic waveforms and higher amplitudes due to the vibration of the vocal cords, whereas the waveforms of unvoiced-speech portions typically include random waveforms and lower amplitudes caused by the lack of vocal cord vibrations.

For instance, the input layers 204 may execute a transformation function on the input audio signal 203 to transform the input audio signal 203 into a transform domain indicating an amount of energy, such as a spectro-temporal representation. The input layers 204 may extract low-level features of the input audio signal 203 from the transform domain. The amount of energy in the input audio signal 203 at the pitch of human speech caused by voiced-speech is distinct from the amount of energy at the pitch of human speech caused by unvoiced-speech. The segmentation engine 208 may identify and analyze the amount of energy in the input audio signal 203 to detect voiced-speech portions and unvoiced-speech portions in the input audio signal 203. The segmentation engine 208 may parse the input audio signal 203 into segments 205 of voiced-speech segments 205a corresponding to the voiced-speech portions and unvoiced-segments 205b corresponding to the unvoiced-speech portions.

As an example, the pitch detector of the segmentation engine 208 analyzes features of the input audio signal 203 to detect periodic energy within a range of human pitch frequencies (approximately 80 Hz to 250 Hz). The pitch detector of the segmentation engine 208 outputs a time series of values representing voiced-speech probabilities that voiced-speech occurs at segments 205 of the input audio signal 203. If the segmentation engine 208 determines that the voiced-speech probability of a given segment exceeds a voiced-speech detection threshold, then the segmentation engine 208 classifies the segment 205 as a voiced-speech segment 205a.

In some implementations, the pitch detector of the segmentation engine 208 outputs a binary signal or value (e.g., ‘0’ or ‘1’) indicating whether each segment 205 of the input audio signal 203 contains voiced-speech. The segmentation engine 208 uses the binary signal to segment or parse the audio into the voiced-speech segments 205a and the unvoiced-speech segments 205b. In some cases, to avoid abrupt transitions and artifacts at the edges of the segments 205, segmentation engine 208 smooths the time series of the binary signal, resulting in a more gradual transition between the voiced-speech portions and unvoiced-speech portions.

As another example, the pitch detector of the segmentation engine 208 processes the input audio signal 203 by first applying a pre-emphasis filter to enhance high-frequency portions of the input audio signal 203. The segmentation engine 208 may divide the input audio signal 203 into overlapping frames, typically using a Hamming window to minimize spectral leakage. For each frame, the segmentation engine 208 executes or computes an autocorrelation function to identify periodicities within the input audio signal 203. A peak in the autocorrelation function indicates the presence of a voiced-speech portion corresponding to a pitch period. In some implementations, after the pitch detector of the segmentation engine 208 determines or identifies pitch periods, the pitch detector calculates a fundamental frequency (FO) for each frame. The segmentation engine 208 classifies each frame with detected FO values as a voiced-speech segment 205a, while frames without such FO values are classified as unvoiced-speech segments 205b. The segmentation engine 208 may also apply a voiced-speech detection threshold to the signal energy or zero-crossing rate to refine the classification further, providing for more-accurate segmentation of voiced-speech portions and unvoiced-speech portions into voiced-speech segments 205a and unvoiced-segments 205b.

Optionally, the input layers 204 includes the SAD engine 206. The SAD engine 206 includes software routines programmed and trained for identifying instances of speech in occurring in input audio signal 203 and parsing the input audio signal 203 into speech segments 205a-205b and non-speech segments 205c, or otherwise identifying or filtering the non-speech segments 205c from the input audio signal 203. The SAD engine 206 identifies the instances of speech by analyzing the input audio signal 203 and detects periods of speech portions and non-speech portions. The SAD engine 206 parses or segments the input audio signal 203 the into the speech segments 205a-205b, when the SAD engine 206 detects instances of one or more speakers' voices present in the input audio signal 203, and the non-speech segments 205c when the SAD engine 206 detects silence or mere background noise or otherwise does not detect a speaker's voice. In some cases, the SAD engine 206 of the input layers 204 generates or outputs the non-speech segments 205c. Additionally or alternatively, in some cases, the SAD engine 206 of the input layers 204 generates or outputs an updated and truncated version of the input audio signal 203 that includes only the speech portions, such that the updated input audio signal 203 omits the identified non-speech segments 205c.

The input layers 204 extract and output the low-level input features of the input audio signal 203 to the SAD engine 206 or the segmentation engine 208. The optional SAD engine 206 may generate the non-speech segments 205c and/or the input audio signal 203 having the speech portions and omitting the non-speech portions. The SAD engine 206 may output and store the non-speech segments 205c and feed the speech portions of the input audio signal 203 to the segmentation engine 208. The segmentation engine 208 may generate the voiced-speech segments 205a and the unvoiced-segments 205b and feed the voiced-speech segments 205a and the unvoiced-segments 205b to the deepfake detector 210.

The machine-learning architecture 202 includes the deepfake detectors 210 for identifying instances of fraudulent input audio signals 203 using the segments 205. The deepfake detectors 210 include a first deepfake detector 210a and a second deepfake detector 210b, and, optionally, a third deepfake detector 210c. The first deepfake detector 210a analyzes the voiced-speech segments 205a to generate a first risk score indicating a likelihood that the voiced-speech segments 205a contain fraud and/or an indicator that the voiced-speech segments 205a are genuine or fraudulent. The second deepfake detector 210b analyzes the unvoiced-speech segments 205b to generate a second risk score indicating a likelihood that the unvoiced-speech segments 205b contain fraud and/or an indicator that the unvoiced-speech segments 205b are genuine or fraudulent. In some embodiments, a third deepfake detector 210c analyzes the features of the entire input audio signal 203, including the voiced-speech segments 205a, the unvoiced-segments 205b, and the non-speech segments 205c to generate a third risk score indicating a likelihood that the whole input audio signal 203 contains fraud and/or an indicator that the whole input audio signal 203 is genuine or fraudulent.

Each deepfake detector 210 includes layers of one or more machine-learning models programmed and trained for extracting features of the input audio signals 203 and identifying instances of deepfakes occurring in the input audio signals 203. The deepfake detector 210 includes an embedding extractor having a machine-learning model, such as a convolutional neural network (CNN), programmed and trained for extracting features and feature vector embeddings (sometimes referred to as “segment fakeprints”) representing the features extracted from the particular segments 205 of input audio signal 203.

In some implementations, the embedding extractor of the deepfake detector 210 executes a transformation function on the particular segments 205 to convert the segments 205 to a transform domain. For example, the deepfake detector 210 ingests the segments 205 in a particular domain representation, such as a raw waveform in a time domain or frequency domain and executes the transformation function to convert the segments 205 into a time-frequency domain (e.g., spectro-temporal representation). The embedding extractor includes a CNN that processes a raw waveform or a feature representation in a transform domain (e.g., spectrogram) to generate or extract the features. The CNN of the embedding extractor process the input segments 205 through a series of layers to extract the fakeprint feature vector embeddings, which are fixed-length feature vectors representing the features extracted from the particular segments 205.

Each deepfake detector 210 includes a machine-learning model programmed and trained to analyze the fakeprint feature vector of the particular segments 205 and generate the risk score indicating a likelihood that a deepfake occurs in the input audio signals 203. The first deepfake detector 210a is trained on the voiced-speech segments 205a, such that the first deepfake detector 210a processes the voiced-speech portions of the waveform to extract the fakeprint of the voiced-speech segments 205a, generate a voice-speech risk score, and classify the input audio signal 203 as bona fide or spoofed. The second deepfake detector 210b is trained on the unvoiced-segments 205b, such that the second deepfake detector 210b processes the unvoiced-speech portions of the waveform to extract the fakeprint of the unvoiced-segments 205, generate an unvoiced-speech risk score, and classify the input audio signal 203 as bona fide or spoofed. The third deepfake detector 210c is trained on the signal segments 205a-205c, such that the third deepfake detector 210c processes the waveform to extract the fakeprint of the signal segments 205a-205c, generate a signal risk score, and classify the input audio signal 203 as bona fide or spoofed. The machine-learning architecture 202 then feeds the respective fakeprint feature vector embeddings to scoring layers and/or classifier layers of the deepfake detectors 210.

The deepfake detectors 210 include scoring layers and/or classifier layers that are programmed and trained to generate the risk score and fraud determination using the corresponding fakeprints. The scoring layers generate the risk scores based upon similarities between the fakeprint and previously trained or generated fraud-detection clusters or centroids. The machine-learning architecture 202 feeds the fakeprint to the fraud classifier or scoring layers to perform various scoring operations. The scoring layers and/or the fraud classifier perform a distance scoring operation that determines the distance (e.g., similarities, differences) between the fakeprint and a centroid or fakeprint feature vector previously generated as fraud-detection cluster using training fakeprints extracted for the training audio signals 203a. Each risk score indicates the likelihood that the input audio signal 203 is genuine or fraudulent, where the particular segments 205 include deepfake or spoofed attributes. The risk score may be a value generated by the scoring layers and/or fraud classifier based on one or more scoring operations (e.g., distance scoring). For instance, the scoring layers or classifier of the deepfake detector 210 determines whether the distance score or other outputted values satisfy threshold values.

The machine-learning architecture 202 includes fusion layers 212 for fusing or otherwise algorithmically combining the risk scores or fraud classifications generated by the one or more deepfake detectors 210. As an example, the first deepfake detector 210a trained on voiced segments 205a outputs a score between 0 and 1, representing the probability that the voiced portions are a fraud containing a deepfake. Similarly, the second deepfake detector 210b trained on the unvoiced segments unvoiced-segments 205b outputs a score between 0 and 1 for the unvoiced portions. The fusion layers 212 combines the risk scores from first deepfake detector 210a and second deepfake detector 210b using a weighted average to generate a signal risk score. In some cases, the machine-learning architecture 202 determines the weights for the fusion layers 212 through logistic regression, trained on the training audio signals 203a to optimize the fusion operations of the fusion layers 212.

Optionally, the third deepfake detector 210c trained on the total segments 205, including the voiced-speech segments 205a, unvoiced segments unvoiced-segments 205b, and non-speech segments 205c, outputs a score between 0 and 1 for the whole input audio signal 203. The fusion layers 212 combines the risk scores from the first deepfake detector 210a, second deepfake detector 210b, and third deepfake detector 210c using a weighted average to generate a signal risk score. In some cases, the machine-learning architecture 202 determines the weights for the fusion layers 212 through logistic regression, trained on the training audio signals 203a to optimize the fusion operations of the fusion layers 212. In some implementations, the 212//generates the overall risk score based upon a comparison or algorithmic combination of the first and second risk scores with the third risk score.

In some embodiments, rather than fusing the final risk scores, the machine-learning architecture 202 fuses the fakeprint embeddings from the embedding extractor of the first deepfake detector 210a and the embedding extractor of the second deepfake detector 210b by concatenating the fakeprints to a complete fakeprint, which the machine-learning architecture 202 feeds to a third deepfake detector 210c that generates a signal risk score. In this way, this approach leverages the combined feature vector embeddings extracted from both the voiced-speech segments 205a and unvoiced-segments 205b.

In some embodiments, a single deepfake detector 210 includes a neural network with attention is programmed and trained to process both the voiced-speech segments 205a and the unvoiced-segments 205b, using attention mechanisms to learn and fuse the relevant fakeprint features internally. This network would output a single, signal risk score based on the combined fakeprint feature vector.

The machine-learning architecture 202 may include an explainability engine 220. The explainability engine 220 includes mechanisms for explainability, such as visualizing the spectral differences between bona fide segments 205 and spoofed segments 205 for display a user interface of a client computing device (e.g., end-user device 114). For instance, the explainability engine 220 implements techniques, such as Shapley Additive Explanations (SHAP), can be used to generate heat maps on the spectrogram, highlighting areas where the energy deviates from naturalness.

The explainability engine 220 may execute operations of, for example, performing spectral analysis, generating visualizations, and generating explainability metrics. The spectral analysis operations may include generating an average magnitude spectrum and performing a baseline comparison. For instance, the explainability engine 220 may computes the average magnitude spectrum for the voiced-speech segments 205a and unvoiced-segments 205b. The explainability engine 220 may average the spectrogram across time to visualize the frequency content of the speech at the voiced-speech segments 205a and unvoiced-segments 205b. To perform the baseline comparison, the explainability engine 220 compares the computed spectrum for the speech segments 205a-205b against a baseline spectrum of bona fide speech segments 205a-205b, stored in a database (e.g., analytics database 104). Significant deviations in the unvoiced regions of the input audio signal 203 can indicate deepfake characteristics.

The visualization operations of the explainability engine 220 may include, for example, spectrogram plotting and heatmaps. As an example, the explainability engine 220 can generate plots of the spectrogram for display in a user interface. The plot user interface may be generated with highlighting at portions of the spectrogram where the energy deviates from naturalness. This helps in visualizing the differences between bona fide and spoofed speech. As another example, the explainability engine 220 can execute a SHAP operation to generate heatmap on the spectrogram, to indicate portions having suspicious energy patterns. This provides a visual representation of the portions that contributes to the deepfake score or deepfake detection classification.

The explainability engine 220 may generate explainability metrics, including spectral separation differences of voiced-speech segments 205a and unvoiced-segments 205b, and auditory feedback. For voiced-speech segments 205a versus unvoiced-segments 205b separation, the explainability engine 220 may analyze the spectral differences in the voiced-speech segments 205a and unvoiced-segments 205b and determine insights into why a particular segment 205 was classified as a deepfake. For instance, the unvoiced-segments 205b often show more pronounced deviations from natural speech, making them critical for explainability. For auditory feedback, the explainability engine 220 may guide an end-user to focus on specific regions of the speech signal, such as unvoiced sounds, which may sound unnatural. This auditory feedback can help the end-user understand the basis of the deepfake detection.

During a training phase, the machine-learning architecture 202 is trained using a set of labeled training audio signals 203a. The server feeds the training audio signals 203a into the input layers 204, where the training audio signals 203a may include any number of genuine and fraudulent audio signals, as indicated by training labels associated with the training audio signals 203a. The training audio signals 203a may be raw audio files or pre-processed according to one or more pre-processing operations. The input layers 204 may perform one or more pre-processing operations on the training audio signals 203a. The input layers 204 extract certain features from the training audio signals 203a and perform various pre-processing and/or data augmentation operations on the training audio signals 203a. As an example, the input layers 204 execute a transform function to convert the training audio signals 203a from a time-frequency domain to a spectro-temporal representation, such as converting the training audio signals 203a into multi-dimensional log filter banks (LFBs).

The input layers 204 executes transformations, converting the training audio signals 203a from a time-frequency domain to a spectro-temporal representation. The input layers 204 are responsible for performing pre-processing operations on the training audio signals 203a. These operations may include, for example, noise reduction for removing background noise to enhance the clarity of voiced-speech segments; normalization for adjusting the amplitude of training audio signals 203a to a consistent range; and transformations for converting training audio signals 203a from a time-frequency domain to a spectro-temporal representation, such as multi-dimensional log filter banks (LFBs).

After the training audio signals 203a are pre-processed, a feature extractor layer or other component of the input layers 204 extracts relevant features. These features include spectral and temporal characteristics that are indicative of voiced-speech portions. The feature extractor of the input layers 204 generates predicted features or feature vectors based on the pre-processed training audio signals 203a. The SAD engine 206 or segmentation engine 208 identifies features, such as pitch frequency, harmonic structure, and energy distribution, to identify speech regions and non-speech regions and/or voiced-speech regions and unvoiced-speech regions. For a training audio signal 203a, the SAD engine 206 identifies and removes predicted non-speech segments 205c and generates an updated version of the training audio signals 203a having voiced-speech regions and unvoiced-speech regions. The segmentation engine 208 executes a machine-learning model (e.g., pitch detector) for identifying voiced-speech regions and unvoiced-speech regions. The segmentation engine 208 parses the training audio signals 203a into the voiced-speech segments 205a corresponding to the voiced-speech regions and the unvoiced-segments 205b corresponding to the unvoiced-speech regions. In some embodiments, the machine-learning architecture 202 includes a loss function that determines a level of error or loss as a measure or value indicating a distance or discrepancy between the predicted voiced-speech segments 205a and expected unvoiced-segments 205b, as indicated by training labels. The machine-learning architecture 202 may adjust or tune the parameters of the segmentation engine 208 to minimize the loss. The server determines that the segmentation engine 208 or input layers 204 are trained when the loss satisfies a corresponding training threshold value.

The deepfake detectors 210 are trained using the voiced-speech segments 205a and unvoiced-segments 205b of a training audio signals 203a to determine whether the training audio signal 203a is genuine or fraudulent. The machine-learning architecture 202 feeds the training voiced-speech segments 205a to the first deepfake detector 210a and the unvoiced-segments 205b to the second deepfake detector 210b. In some implementations, the embedding extractors of the first deepfake detector 210a and second deepfake detector 210b may extract respective predicted fakeprints. The first deepfake detector 210a uses the predicted fakeprint extracted for the voiced-speech segments 205a to generate a first risk score and predicted classification of the training audio signals 203a. The first deepfake detector 210a determines that the training audio signal 203a is a predicted genuine signal or predicted fraud signal in response to the determining that the predicted first risk score satisfies one or more thresholds. The second deepfake detector 210b uses the predicted fakeprint extracted for the unvoiced-segments 205b to generate a second risk score and predicted classification of the training audio signals 203a. The second deepfake detector 210b determines that the training audio signal 203a is a predicted genuine signal or predicted fraud signal in response to the determining that the predicted second risk score satisfies one or more thresholds.

In some implementations, the embedding extractor of the third deepfake detector 210c may extract a third predicted fakeprint for the whole training audio signal 203a, including the voiced-speech segments 205a, unvoiced-segments 205b, and in some cases, the non-speech segments 205c. The third deepfake detector 210c uses the third predicted fakeprint extracted for the whole training audio signal 203a to generate a third risk score and predicted classification of the training audio signals 203a. The third deepfake detector 210c determines that the training audio signal 203a is a predicted genuine signal or predicted fraud signal in response to the determining that the predicted third risk score satisfies one or more thresholds.

The fusion layers 212 may perform operations to algorithmically combine the risk scores or classifications from the deepfake detectors 210, which may include concatenating or computing a weighted average. The fusion layers 212 may generate an overall risk score and predicted overall classification of the training audio signal 203a. The fusion layers 212 may include a classifier layer that determines that the training audio signal 203a is a predicted genuine signal or predicted fraud signal in response to the determining that the predicted overall risk score satisfies one or more thresholds.

As mentioned, the machine-learning architecture 202 includes one or more loss functions for training the deepfake detectors 210, fusion layers 212, and other components of the machine-learning architecture 202. For instance, a loss function may determine a level of error or loss for the deepfake detectors 210 or fusion layers 212 based upon a difference or discrepancy between the predicted output(s) (e.g., predicted risk score, predicted classification) and expected output(s) (e.g., expected risk score, expected classification) indicated by a training label for the training audio signal 203a. Throughout the training process, the server continually optimizes and adjusts the parameters of the deepfake detector 210 or fusion layers 212 using backpropagation and loss minimization to adjust the parameters of the deepfake detector 210 or fusion layers 212. The server determines that the deepfake detector 210 or fusion layers 212 is trained when the loss satisfies a corresponding training threshold value.

At deployment, the server receives an inbound audio signal 203b and executes the machine-learning architecture 202 on the inbound audio signals 203b. The machine-learning architecture 202 feeds the inbound audio signal 203b to the input layers 204 to perform various preprocessing operations on the inbound audio signal 203b, which includes extracting features of the inbound audio signal 203b, executing the SAD engine 206 to identify non-speech segments 205c, and executing the segmentation engine 208 to generate the voiced-speech segments 205a and unvoiced-segments 205b for the particular inbound audio signal 203b.

The SAD engine 206 identifies inbound non-speech regions of the inbound audio signal 203b. The SAD engine 206 is trained to identify various acoustic features, such as pitch frequency, harmonic structure, and energy distribution to identify the non-speech regions. The SAD engine 206 may generate and store inbound non-speech segments 205c corresponding to the identified inbound non-speech regions of the inbound audio signal 203b. In some cases, the SAD engine 206 generates a shortened version of the inbound audio signal 203b containing only speech regions of voiced-speech regions and unvoiced-speech regions.

The segmentation engine 208 receives the inbound audio signal 203b and identifies inbound voiced-speech regions and inbound unvoiced-speech regions of the inbound audio signal 203b. The trained segmentation engine 208 receives the inbound audio signal 203b and analyzes the various inbound features extracted from the inbound audio signal 203b using the feature extractor of the input layers 204. For instance, the segmentation engine 208 includes a pitch detector having a machine-learning model trained to detect the inbound features representing signal attributes, such as pitch frequency, harmonic structure, and energy distribution. As an example, the voiced-speech portions correspond to instances where the speech is produced with vocal fold vibration, leading to a harmonic structure. As another example, the unvoiced-speech regions correspond to instances where the speech occurs without vocal fold vibration, often producing more noise-like characteristics or randomized structures. The inbound audio signal 203b detects the inbound voiced-speech portions and the inbound unvoiced-speech portions. The segmentation engine 208 then parses the inbound audio signal 203b into distinct inbound voiced-speech segments 205a and inbound unvoiced-segments 205b corresponding to the inbound voiced-speech portions and inbound unvoiced-speech portions.

The machine-learning architecture 202 feeds the inbound segments 205 generated for the inbound audio signal 203b to the respective deepfake detectors 210. The first deepfake detector 210a ingests the inbound voiced-speech segments 205a and extracts a first inbound fakeprint feature vector embedding for the features of the inbound voiced-speech segments 205a. The scoring layers and/or classifier of the first deepfake detector 210a generate the first inbound risk score and/or the first inbound risk classification. The second deepfake detector 210b ingests the inbound unvoiced-segments 205b and extracts a second inbound fakeprint feature vector embedding for the features of the inbound unvoiced-segments 205b. The scoring layers and/or classifier of the second deepfake detector 210b generate the second inbound risk score and/or the second inbound risk classification.

Optionally, the third deepfake detector 210c ingests the inbound total audio signal 203b having the inbound voiced-speech segments 205a, inbound unvoiced-segments 205b, and inbound non-speech segments 205c. The third deepfake detector 210c then extracts a third inbound fakeprint feature vector embedding for the features of the inbound total inbound audio signal 203b. The scoring layers and/or classifier of the third deepfake detector 210c generate the third inbound risk score and/or the third inbound risk classification.

The fusion layers 212 algorithmically combine the risk scores or fraud classifications generated by the deepfake detectors 210 to generate an inbound overall risk score and/or inbound overall classification for the inbound audio signal 203b. As an example, the first deepfake detector 210a generates a first risk score between 0 and 1 using the fakeprint of the inbound voiced-speech segments 205a of the inbound audio signal 203b, representing the probability that the inbound voiced-speech portions are a fraud containing a deepfake. Similarly, the second deepfake detector 210b generates a second risk score between 0 and 1 using the fakeprint of the inbound unvoiced-segments 205b, representing the probability that the inbound unvoiced-speech portions are a fraud containing a deepfake. The fusion layers 212 combines the first and second risk scores from first deepfake detector 210a and the second deepfake detector 210b using a weighted average to generate the inbound overall signal risk score. In some cases, the machine-learning architecture 202 determines the weights for the fusion layers 212 through logistic regression, trained on the training audio signals 203a to optimize the fusion operations of the fusion layers 212.

In some implementations, the third deepfake detector 210c generates a third risk score between 0 and 1 using the fakeprint of the inbound total signal of the inbound audio signal 203b, representing the probability that the inbound audio signal 203b is fraudulent containing a deepfake. In some case, the fusion layers 212 combines the first, second, and third risk scores using a weighted average to generate the inbound overall signal risk score. In some cases, the fusion layers 212 includes scoring layers that determine or update the first and second risk scores based upon a comparison or difference to the third risk score.

Scoring layers or classifier layers of the fusion layers 212 can determine whether the input audio signal 203b is genuine or fraudulent. For instance, the fusion layers 212 may determine that the inbound audio signal 203b is a fraudulent signal containing a fraud, in response to the fusion layers 212 determining that the inbound overall risk score satisfies a fraud detection threshold and classifies the inbound audio signal 203b as genuine or fraud as the overall classification for the inbound audio signal 203b.

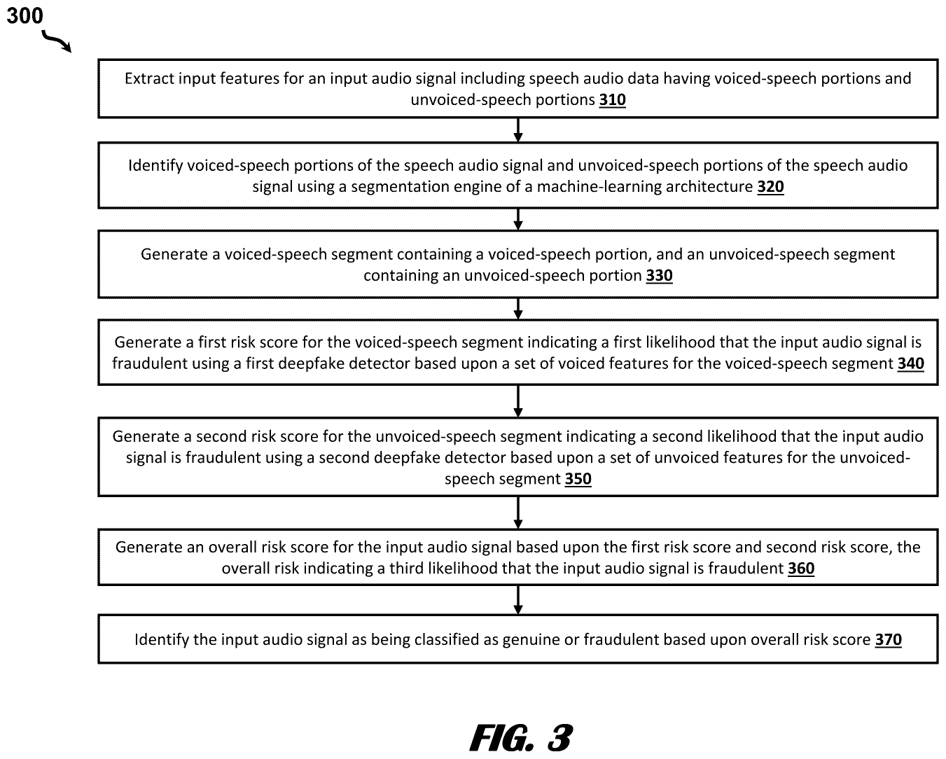

FIG. 3 is a flowchart showing operations of a computer-implemented method 300 for deepfake detection in caller audio using a machine-learning architecture based on voiced-speech and unvoiced-speech, according to an embodiment.

At operation 310, a computer (e.g., analytics server 102 of FIG. 1, server of FIG. 2) extracts input features for an input audio signal including speech audio data having voiced-speech portions and unvoiced-speech portions.

At operation 320, the computer identifies one or more voiced-speech portions of the speech audio signal and an unvoiced-speech portion of the speech audio signal using a segmentation engine of a machine-learning architecture. The segmentation engine is trained to identify instances of voiced-speech portions and/or unvoiced-speech portions according to the input features extracted from the input audio signal.

At operation 330, the computer generates one or more voiced-speech segments containing the one or more voiced-speech portions, and one or more unvoiced-speech segments containing the one or more unvoiced-speech portions. The voiced-speech segments include or correspond to the input features extracted for the voiced-speech speech portions. The unvoiced-speech segments include or correspond to the input features extracted for the unvoiced-speech speech portions.

At operation 340, the computer generates a first risk score for the voiced-speech segment using a first deepfake detector of the machine-learning architecture. The first deepfake detector is trained to generate the first risk score based upon a set of voiced-speech features extracted using an embedding extractor of the first deepfake detector for the voiced-speech segments. The first risk score indicates a first likelihood that the input audio signal is fraudulent.

At operation 350, the computer generates a second risk score for the unvoiced-speech segment using a second deepfake detector of the machine-learning architecture. The second deepfake detector is trained to generate the second risk score based upon a set of unvoiced-speech features extracted using an embedding extractor of the second deepfake detector for the voiced-speech segments. The second risk score indicates a second likelihood that the input audio signal is fraudulent.

At operation 360, the computer generates an overall risk score for the input audio signal based upon the first risk score and second risk score. In some cases, the computer executes fusion layers programmed and/or trained to algorithmically combine the first risk score and the second risk (or other types of risk scores) to generate the overall risk score. The overall risk score indicate a third likelihood that the input audio signal is fraudulent.

At operation 370, the computer identifies the input audio signal as genuine or fraudulent based upon overall risk score. The computer compares the overall risk score against a fraud detection threshold score. The server identifies the input audio signal as fraudulent in response to determining that the overall score satisfies the fraud detection threshold score.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method for detecting fraudulent speech based on voiced-speech and unvoiced-speech, the method comprising:
extracting, a computer, input features for an input audio signal including speech audio data having voiced-speech portions and unvoiced-speech portions;
identifying, by the computer, a voiced-speech portion of the speech audio signal and an unvoiced-speech portion of the speech audio signal using a segmentation engine of a machine-learning architecture, the segmentation engine trained to identify instances of at least one of voiced-speech portions or unvoiced-speech portions according to the input features;
generating, by the computer, a voiced-speech segment containing the voiced-speech portion from the speech audio data and an unvoiced-speech segment containing the unvoiced-speech portion from the speech audio data;
generating, by the computer, a first risk score for the voiced-speech segment indicating a first likelihood that the input audio signal is fraudulent using a first deepfake detector of the machine-learning architecture based upon a set of voiced features for the voiced-speech segment;
generating, by the computer, a second risk score for the unvoiced-speech segment of the input audio signal indicating a second likelihood that the input audio signal is fraudulent using a second deepfake detector of the machine-learning architecture based upon a set of unvoiced features for the unvoiced-speech segment;
generating, by the computer, an overall risk score for the input audio signal based upon the first risk score and second risk score, the overall risk indicating a third likelihood that the input audio signal is fraudulent; and
identifying, by the computer, the input audio signal as genuine or fraudulent based upon overall risk score.

2. The method according to claim 1, further comprising extracting, by the computer, the set of voiced features for the voiced-speech segment and the set of unvoiced features for the unvoiced-speech segment.

3. The method according to claim 2, further comprising:
extracting, by the computer, a first fakeprint feature vector embedding using the set of voiced features for the voiced-speech segment; and
extracting, by the computer, a second fakeprint feature vector embedding using the set of unvoiced features for the unvoiced-speech segment.

4. The method according to claim 1, further comprising detecting, by the computer, the voiced-speech portion based upon a pitch frequency indicative of the voiced-speech using a pitch detector of the segmentation engine.

5. The method according to claim 1, further comprising detecting, by the computer, the unvoiced-speech based upon a pitch frequency indicative of the unvoiced-speech using a pitch detector of the segmentation engine.

6. The method according to claim 1, further comprising:
detecting, by the computer, a non-speech portion of the input audio signal using a Speech Activity Detection (SAD) engine trained to trained to identify instances of non-speech portions according to the input features;
generating, by the computer, a non-speech segment containing the non-speech portion from the input audio signal; and
filtering, by the computer, the non-speech segment from the input audio signal.

7. The method according to claim 6, further comprising:
generating, by the computer, a third risk score for the input audio signal indicating a fourth likelihood that the input audio signal is fraudulent using a third deepfake detector of the machine-learning architecture based upon a set of features for the input audio signal having the voiced-speech segment, unvoiced-speech segment, and non-speech segment,
wherein the computer generates the overall risk score based upon the first risk score, the second risk score, and the third risk score.

8. The method according to claim 1, further comprising:
generating, by the computer, a loss for the machine-learning architecture using a loss function, the loss indicating a distance between the overall risk score as generated for the input audio signal and an expected overall risk score indicated by a training label associated with the input audio signal; and
updating, by the computer, one or more parameters of at least one of the first deepfake detector or the second deepfake detector based upon the loss.

9. The method according to claim 1, further comprising:
generating, by the computer, a loss for a first deepfake detector using a loss function, the loss indicating a distance between the first risk score as generated for the voiced-speech segment and an expected first risk score indicated by a training label associated with the input audio signal; and
updating, by the computer, one or more parameters of the first deepfake detector based upon the loss.

10. The method according to claim 1, further comprising:
generating, by the computer, a loss for a second deepfake detector using a loss function, the loss indicating a distance between the second risk score as generated for the unvoiced-speech segment and an expected second risk score indicated by a training label associated with the input audio signal; and
updating, by the computer, one or more parameters of the second deepfake detector based upon the loss.

11. A system for detecting fraudulent speech based on voiced-speech and unvoiced-speech, the system comprising:
a computer comprising at least one processor, the computer configured to:
extract input features for an input audio signal including speech audio data having voiced-speech portions and unvoiced-speech portions;
identify a voiced-speech portion of the speech audio signal and an unvoiced-speech portion of the speech audio signal using a segmentation engine of a machine-learning architecture, the segmentation engine trained to identify instances of at least one of voiced-speech portions or unvoiced-speech portions according to the input features;
generate a voiced-speech segment containing the voiced-speech portion from the speech audio data, and an unvoiced-speech segment containing the unvoiced-speech portion from the speech audio data;
generate a first risk score for the voiced-speech segment indicating a first likelihood that the input audio signal is fraudulent using a first deepfake detector of the machine-learning architecture based upon a set of voiced features for the voiced-speech segment;
generate a second risk score for the unvoiced-speech segment of the input audio signal indicating a second likelihood that the input audio signal is fraudulent using a second deepfake detector of the machine-learning architecture based upon a set of unvoiced features for the unvoiced-speech segment;
generate an overall risk score for the input audio signal based upon the first risk score and second risk score, the overall risk indicating a third likelihood that the input audio signal is fraudulent; and
identify the input audio signal as genuine or fraudulent based upon overall risk score.

12. The system according to claim 11, wherein the computer is further configured to extract the set of voiced features for the voiced-speech segment and the set of unvoiced features for the unvoiced-speech segment.

13. The system according to claim 12, wherein the computer is further configured to:
extract a first fakeprint feature vector embedding using the set of voiced features for the voiced-speech segment; and
extract a second fakeprint feature vector embedding using the set of unvoiced features for the unvoiced-speech segment.

14. The system according to claim 11, wherein the computer is further configured to detect the voiced-speech portion based upon a pitch frequency indicative of the voiced-speech using a pitch detector of the segmentation engine.

15. The system according to claim 11, wherein the computer is further configured to detect the unvoiced-speech based upon a pitch frequency indicative of the unvoiced-speech using a pitch detector of the segmentation engine.

16. The system according to claim 11, wherein the computer is further configured to:
detect a non-speech portion of the input audio signal using a Speech Activity Detection (SAD) engine trained to trained to identify instances of non-speech portions according to the input features;
generate a non-speech segment containing the non-speech portion from the input audio signal; and
filter the non-speech segment from the input audio signal.

17. The system according to claim 11, wherein the computer is further configured to:
generate a third risk score for the input audio signal indicating a fourth likelihood that the input audio signal is fraudulent using a third deepfake detector of the machine-learning architecture based upon a set of features for the input audio signal having the voiced-speech segment, unvoiced-speech segment, and non-speech segment,
wherein the computer generates the overall risk score based upon the first risk score, the second risk score, and the third risk score.

18. The system according to claim 11, wherein the computer is further configured to:
generate a loss for the machine-learning architecture using a loss function, the loss indicating a distance between the overall risk score as generated for the input audio signal and an expected overall risk score indicated by a training label associated with the input audio signal; and
update one or more parameters of at least one of the first deepfake detector or the second deepfake detector based upon the loss.

19. The system according to claim 11, wherein the computer is further configured to:
generate a loss for a first deepfake detector using a loss function, the loss indicating a distance between the first risk score as generated for the voiced-speech segment and an expected first risk score indicated by a training label associated with the input audio signal; and
update one or more parameters of the first deepfake detector based upon the loss.

20. The system according to claim 11, wherein the computer is further configured to:
generate a loss for a second deepfake detector using a loss function, the loss indicating a distance between the second risk score as generated for the unvoiced-speech segment and an expected second risk score indicated by a training label associated with the input audio signal; and
update one or more parameters of the second deepfake detector based upon the loss.
